(19) United States
(12) Patent Application Publication
(10) Pub. No.: US 2017/0082793 A1
(43) Pub. Date: Mar. 23, 2017

(54) BACKLIGHT MODULE, DISPLAY MODULE AND ELECTRONIC DEVICE

(71) Applicants: BOE TECHNOLOGY GROUP CO., LTD., Beijing (CN); XIAMEN BOE ELECTRONICS CO., LTD., Xiamen (CN)

(72) Inventor: Huiqiang YE, Beijing (CN)

(21) Appl. No.: 15/315,570

(22) PCT Filed: Mar. 1, 2016
(86) PCT No.: PCT/CN2016/075202

§ 371 Date: Dec. 1, 2016

(30) Foreign Application Priority Data
Sep. 23, 2015 (CN) 201510611892.3

(51) Int. Cl. F21V 8/00

(52) U.S. Cl. CPC G02B 6/0051; G02B 6/0068; G02B 6/0055; G02B 6/0053

(57) ABSTRACT

The embodiments of the present disclosure disclose a backlight module, a display module and an electronic device. The backlight module comprises a backlight source and a light guide plate, wherein the backlight source comprises: a first light emitting unit, and a second light emitting unit positioned at least one end of the first light emitting unit, the first light emitting unit and the second light emitting unit are disposed on the light incoming side of the light guide plate, and the light outgoing surface of the first light emitting unit and the light outgoing surface of the second light emitting unit form an angle of greater than 180° and less than 270°. The backlight module provided in the embodiment of the present disclosure can improve the display effect of the display module.

### CROSS-REFERENCES TO RELATED APPLICATIONS

This application claims priority of Chinese Patent Application No. 201510611892.3, filed on Sep. 23, 2015, the entire content of which is incorporated by reference herein.

### FIELD

Embodiments of the present disclosure relate to the field of display technology, and particularly, to a backlight module, a display module and an electronic device.

### BACKGROUND

With the rapid development of electronic technology, smart watches have been widely used in production and daily life. A smart watch can display information through a display module disposed in it.

For example, the display module may include a display panel and a backlight module, wherein the backlight module may include a light emitting diode (LED) light bar and a light guide plate, which light guide plate is typically a edge type light guide plate, i.e., the light emitted from the LED light bar is incident into the light guide plate from the side face of the light guide plate and guided by the light guide plate, and then emerges from the light outgoing surface of the light guide plate; the display panel is disposed on the side face of the light guide plate close to the light outgoing surface. The side face of the light guide plate is in contact with the LED light bar, and the connecting surface of the LED light bar and the light guide plate is a plane. The light emitted from the LED light bar can be incident into the light guide plate from the side face of the light guide plate and emerge from the light outgoing surface of the light guide plate, finally incident into the display panel for displaying information.

As light emitted by the LED light bar is relatively concentrated, and the length of the LED light bar is usually less than the width of the light guide plate, the illuminance of a region (such as the middle region) of the light outgoing surface of the light guide plate illuminated by the LED light bar is strong, while the illuminance of other regions (such as edge regions) is weak. As a result, the uniformity of illuminance of the light outgoing surface of the light guide plate is low, resulting in a poor display effect of the display module.

### SUMMARY

The embodiments of the disclosure provide a backlight module, a display module and an electronic device, which can provide more uniform light irradiation for a display panel, and achieve a better display effect.

According to a first aspect of an embodiment of the present disclosure, there is provided a backlight module including a backlight source and a light guide plate, wherein the backlight source comprises: a first light emitting unit; and a second light emitting unit positioned at least one end of the first light emitting unit, the first light emitting unit and the second light emitting unit being disposed on the light incoming side of the light guide plate, the light outgoing surface of the first light emitting unit and the light outgoing surface of the second light emitting unit form an angle greater than 180° and less than 270°.

In one example, the backlight module further includes a reflective film, a diffusion film, and a prism film, wherein the diffusion film and the prism film are sequentially superimposed on the light outgoing surface of the light guide plate, the reflective film is disposed on the back surface of the light guide plate; the reflective film, the diffusion film, the prism film, and the light guide plate are each a cylinder, and the bottom surface of at least one cylinder of the reflective film, the diffusion film, the prism film, and the light guide plate has an asymmetrical shape.

In one example, the backlight source further includes a base disposed on the light incoming side of the light guide plate, the first light emitting unit being disposed on a surface of the base close to the light guide plate, a protrusion being formed on the surface of the base close to the light guide plate, wherein the protrusion is positioned at least one end of the first light emitting unit, a height of one end of the protrusion close to the first light emitting unit is larger than that of another end of the protrusion away from the first light emitting unit, and the second light emitting unit is disposed on a surface of the protrusion close to the light guide plate.

In one example, the light incoming surface on the light incoming side of the light guide plate is provided as an uneven surface such that the shape of the light incoming surface of the light guide plate matches the shape of the surface of the backlight light source facing the light guide plate.

In one example, the light outgoing surface of at least one of the first light emitting unit and the second light emitting unit is in contact with the light incoming surface of the light guide plate.

In one example, the display regions of the reflective film, the diffusion film, the prism film, and the light guide plate are in a circular shape, and the bottom surfaces of the reflective film, the diffusion film, the prism film, and the light guide plate have the same shape and area, and are all in an asymmetrical shape.

In one example, the backlight source includes one first light emitting unit and two second light emitting units, the two second light emitting units being disposed symmetrically at both ends of the first light emitting unit.

In one example, the first light emitting unit and the second light emitting unit are light emitting diodes.

In one example, the magnitude of the angle formed between the light outgoing surface of the first light emitting unit and the light outgoing surface of the second light emitting unit is proportional to the diameter of the circle.

In one example, the light outgoing surface of the first light emitting unit and the light outgoing surface of the second light emitting unit form an angle of 183°.

In one example, the diameter of the circle is 38.7 mm.

In one example, the backlight module further includes a light-shielding film, a backplane, and a sealant, wherein the light-shielding film is disposed on a side of the prism film away from the light outgoing surface of the light guide plate, the backplane is disposed on a side of the reflective film away from the back face of the light guide plate, and the rubber frame is disposed on the periphery of the light guide plate and the backlight source.

According to a second aspect of an embodiment of the present disclosure, there is provided a display module including any one of the backlight modules according to the first aspect of the embodiment of the present disclosure.

According to a third aspect of an embodiment of the present disclosure, there is provided an electronic device including any one of the display modules according to the second aspect of the embodiment of the present disclosure.

An embodiment of the present disclosure provides a backlight module, a display module, and an electronic device. The light outgoing surface of the first light emitting unit and the light outgoing surface of the second light emitting unit form an angle of more than 180° and less than 270°, so that the light emitted from the first light emitting unit and the second light emitting unit may diffuse to the edge portion of the side face of the light guide plate, that is, the backlight source emits divergent light so that the light emerges relatively uniformly from the respective areas on the light outgoing surface of the light guide plate, thereby improving the uniformity of illuminance of the light outgoing surface of the light guide plate, and further improving the display effect of the display module.

It should be understood that both the foregoing general description and the following detailed description are exemplary and explanatory only and are not restrictive of the disclosure.

### BRIEF DESCRIPTION OF THE DRAWINGS

In order to more clearly illustrate the technical solution in the embodiments of the present disclosure, the drawings to be used in the embodiments will be briefly described below. Apparently, the drawings described below are only exemplary drawings for some embodiments of the present disclosure. Those of ordinary skill in the art may also obtain other drawings according to these drawings without creative work.

FIG. 1 is a schematic structural view of a backlight module according to an embodiment of the present disclosure;

FIG. 2 is a side view of a backlight module according to an embodiment of the present disclosure;

FIG. 3 is a front view of the backlight module shown in FIG. 2;

FIG. 4 is a schematic partial structural view of the backlight module shown in FIG. 3;

FIG. 5 is another schematic partial structural view of the backlight module shown in FIG. 3;

FIG. 6 is a schematic structural view of a display module according to an embodiment of the present disclosure.

### DETAILED DESCRIPTION

To make the purpose, technical solutions, and advantages of the present disclosure clearer, embodiments of the present disclosure will be further described in detail with reference to the following drawings. Apparently, the embodiments described are merely part of the embodiments of the present disclosure and are not exhaustive. Based on the embodiments described herein, all the other embodiments obtained by those of ordinary skill in the art, without creative work, fall within the scope of protection of the present disclosure.

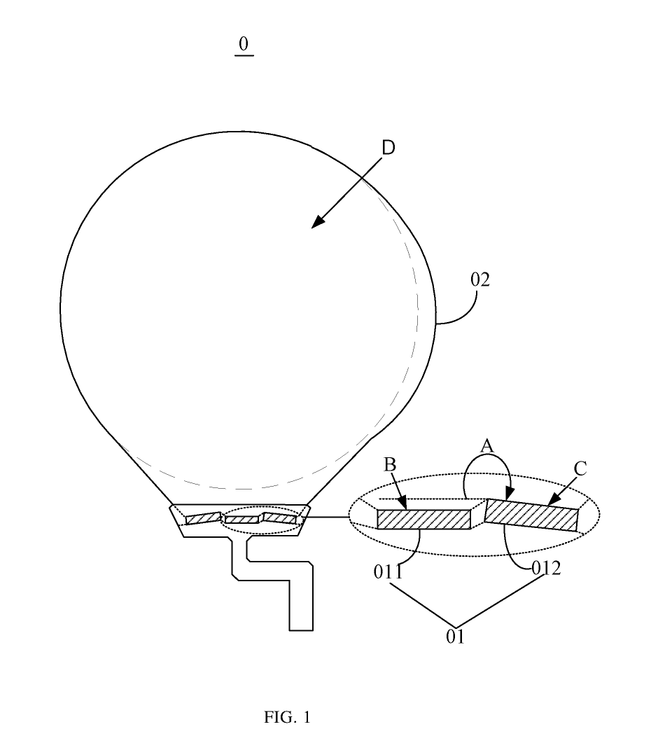

As shown in FIG. 1, the embodiment of the present disclosure provides a backlight module 0 which may include a backlight source 01 and a light guide plate 02, wherein the backlight source 01 may include a first light emitting unit 011, and a second light emitting unit 012 disposed at least one end of the first light emitting unit 011.

In the embodiment of the present disclosure, the first light emitting unit 011 and the second light emitting unit 012 each may be disposed on the light incoming side of the light guide plate 02, the light outgoing surface B of the first light emitting unit 011 and the light outgoing surface C of the second light emitting unit 012 form an angle (A) of more than 180° and less than 270° so that the light emitted from the first light emitting unit 011 and the second light emitting unit 012 can relatively uniformly enter into the light guide plate from the entire light incoming surface of the light guide plate 02, and after being guided by the light guide plate, emerge from the light outgoing surface D of the light guide plate 02.

As an example, when the backlight module provided in the embodiments of the present disclosure is used for a display panel of a smart watch, the light guide plate may be disposed below the display panel, and the first light emitting unit and the second light emitting unit may be disposed on the side face of the light guide plate, so that the light is coupled from the side face into the light guide plate, and after being guided by the light guide plate, is directed toward the display panel from the light outgoing surface of the light guide plate.

As described above, in the backlight module provided in the embodiment of the present disclosure, the light outgoing surface of the first light emitting unit and the light outgoing surface of the second light emitting unit form an angle of greater than 180° and less than 270°, so that light emitted from the backlight source may diffuse to the edge portions of the side face of the light guide plate, that is, the backlight source emits divergent light so that the light emerges relatively uniformly from the respective regions on the light outgoing surface of the light guide plate, thereby improving the uniformity of illuminance of the light outgoing surface of the light guide plate, and further improving the display effect of the display module.

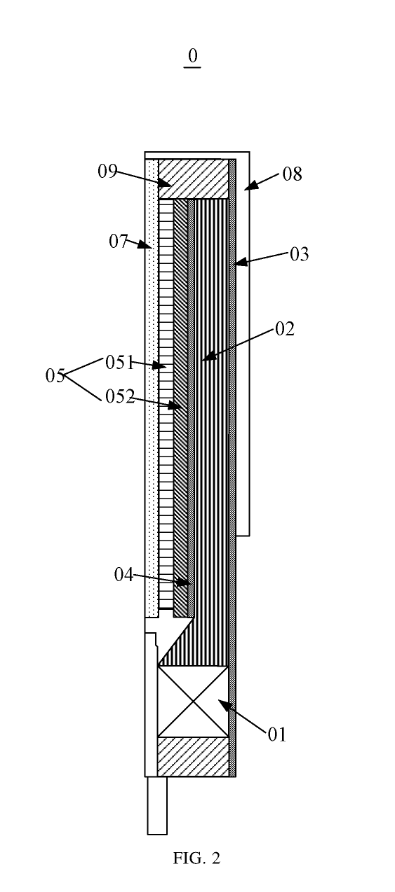

FIG. 2 is a side view of a backlight module 0 according to an embodiment of the present disclosure. As shown in FIG. 2, the backlight module 0 may further include a reflective film 03, a diffusion film 04, and a prism film 05. Wherein, the diffusion film 04 and the prism film 05 are sequentially superimposed on the light outgoing surface of the light guide plate 02, and the reflection film 03 is disposed on the back surface of the light guide plate 02. In one embodiment, the prism film 05 may include an upper prism 051 and a lower prism 052.

In one embodiment, the backlight module 0 may further include a light shielding film 07, a backplane 08 and a sealant 09, the light shielding film 07 being provided on a side of the light outgoing surface of the prism film 05 away from the light guide plate 02, the backplane 08 being provided on the side of the reflective film 03 away from the back surface of the light guide plate 02, and the sealant 09 being provided on the periphery of the light guide plate 02 and the backlight source 01.

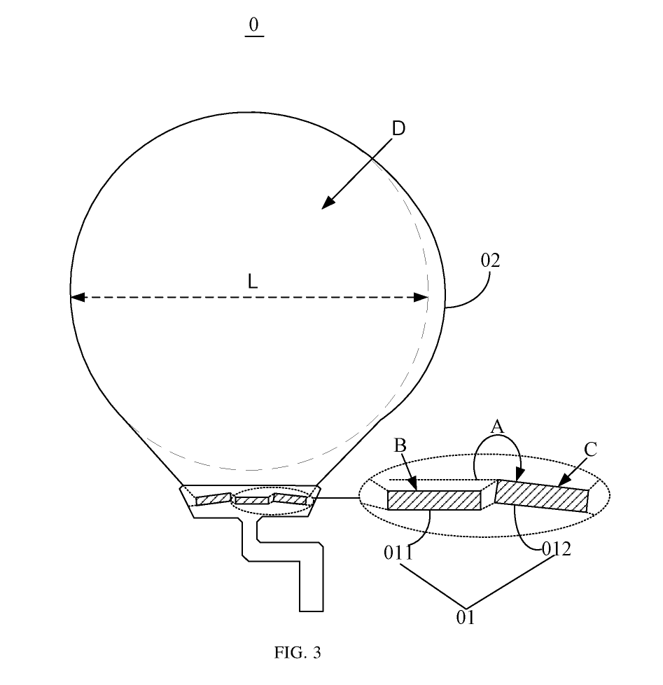

In one embodiment, the reflective film 03, the diffusion film 04, the prism film 05, and the light guide plate 02 each may be a cylinder, and alternatively, the bottom surface of at least one of the reflective film 03, the diffusion film 04, the prism film 05, and the light guide plate 02 may have an asymmetric shape. By way of example, the display regions of the reflective film 03, the diffusion film 04, the prism film 05, and the light guide plate 02 may be circular (as shown by broken lines in FIG. 3), and the bottom surfaces of the reflective film 03, the diffusion film 04, the prism film 05 and the light guide plate 02 may have the same shape and area, and each has an asymmetrical shape. In the present embodiment, the bottom surfaces of the reflective film, the diffusion film, the prism film, and the light guide plate 02 are provided with an asymmetrical shape, and when the reflective film, the diffusion film, the prism film, and the light guide plate 02 are assembled into the backlight module 0, it is possible to prevent the reflective film, the diffusion film, the prism film, and the light guide plate 02 from being assembled with front and back surfaces reversed, thereby preventing fool-proofing. Further, the light guide plate 02 having a circular display region, the reflective film having a circular display region, the diffusion film having a circular display region, and the prism film having a circular display region can be applied to an electronic device having a circular display surface, such as a watch having a circular dial.

As shown in FIG. 3, the backlight source 01 may include one first light emitting unit 011, and two second light emitting units 012, and the two second light emitting units 012 are symmetrically disposed at both ends of the first light emitting unit 011. In one embodiment, both the first light emitting unit 011 and the second light emitting unit 012 may be LEDs, i.e. the backlight source 01 may include three LEDs.

In one embodiment, the light outgoing surface B of the first light emitting unit 011 and the light outgoing surface C of the second light emitting unit 012 form an angle A which may be 183°. In one embodiment, the diameters L of the circular display regions of the reflective film, the diffusion film, the prism film, and the light guide plate 02 may be 38.7 mm. As an alternative embodiment, the magnitude of the angle formed between the light outgoing surface B of the first light emitting unit 011 and the light outgoing surface C of the second light emitting unit 012 may be proportional to the diameter L of the circular display region.

The material formed the light guide plate 02 may be a polycarbonate (abbreviated as PC), and the refractive index of the light guide plate 02 may be 1.59. It should be noted that the material formed the light guide plate may also be other materials, and the refractive index of the light guide plate may also be other values. The present disclosure is not limited thereto.

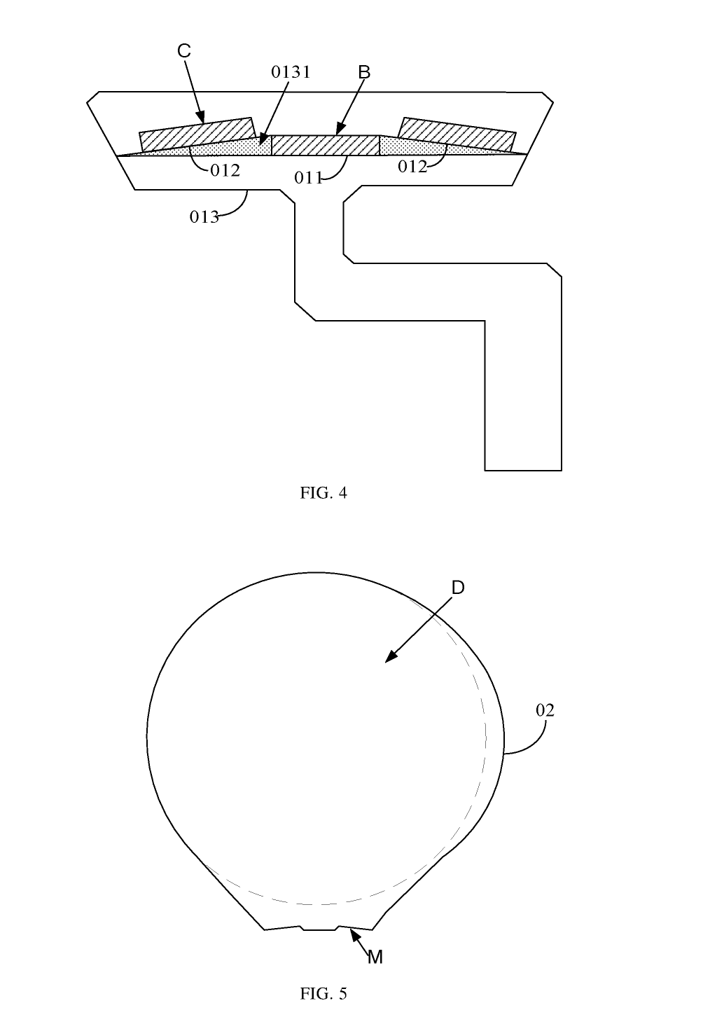

FIG. 4 is a schematic partial structural view of the backlight module shown in FIG. 3. As shown in FIG. 4, in one embodiment, the backlight source 01 may further include a base 013 provided on the light incoming side of the light guide plate 02. It should be noted that the side where the light incoming surface of the light guide plate 02 is located is the light incoming side of the light guide plate 02. Wherein, the first light emitting unit 011 is provided on the surface of the base 013 close to the light guide plate 02. A protrusion 0131 is formed on the surface of the base 013 close to the light guide plate 02, and is located at least one end of the first light emitting unit 011, the height of one end of the protrusion 0131 close to the first light emitting unit 011 is greater than that of another end of the protrusion 0131 away from the first light emitting unit 011, and the second light emitting unit 012 is disposed on the surface of the protrusion 0131 close to the light guide plate 02. In one embodiment, the surface of the protrusion 0131 close to the light guide plate 02 may be set as a plane.

Since the first light emitting unit 011 in FIG. 4 is provided with the second light emitting units 012 on both sides thereof, two protrusions 0131 are formed on the base 013, and the two protrusions 0131 are located at the both ends of the first light emitting unit 011 respectively.

According to an embodiment of the present disclosure, a protrusion 0131 is formed on the base 013, and the height of one end of the protrusion 0131 close to the first light emitting unit 011 is larger than that of another end of the protrusion 0131 away from the first light emitting unit 011, so that an angle between the light outgoing surface C of the second light emitting unit 012 provided on the protrusion 0131 and the light outgoing surface B of the first light emitting unit 011 is greater than 180° and smaller than 270°.

Further, at least one light outgoing surface of the light outgoing surface B of the first light emitting unit 011 and the light outgoing surface C of the second light emitting unit 012 may be in contact with the light incoming side of the light guide plate 02. Alternatively, both the light outgoing surface B of the first light emitting unit 011 and the light outgoing surface C of the second light emitting unit 012 are in contact with the light incoming side of the light guide plate 02. In this embodiment, the light outgoing surface B and the light outgoing surface C on the backlight source are both in contact with the light incoming surface of the light guide plate 02, so that both the light emitted from the light outgoing surface B and the light outgoing surface C on the backlight source can enter into the light guide plate 02 from the light incoming surface of the light guide plate 02, and exit the light guide plate 02 from the light outgoing surface of the light guide plate 02. Therefore, the larger the amount of light enters into the light guide plate 02, the more the light emerges from the light outgoing surface of the light guide plate 02, the better the display effect of the backlight module, thereby improving the utilization of light energy.

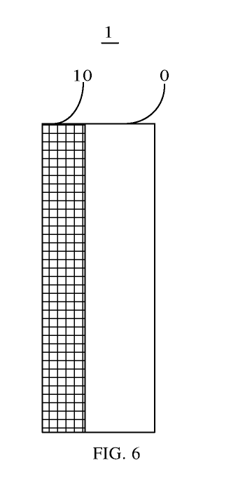

FIG. 5 is another schematic partial structural view of the backlight module shown in FIG. 3. Since the second light emitting unit is provided on the protrusion, as described above, the surface of the backlight source facing the light guide plate is formed with protrusions and recesses, i.e., the surface of the backlight that facing the light guide plate is an uneven plane. In one embodiment, the light incoming surface M of the light guide plate 02 may also be provided as an uneven surface so that the light incoming surface M of the light guide plate 02 can match with the surface of the backlight source facing the light guide plate 02, and when the backlight source and the light guide plate are assembled together, they can be installed accurately and quickly, facilitating the coupling of the light emitted from the backlight source into the light guide plate, thereby improving the utilization of light.

In one embodiment, when assembling the backlight module, a sealant may be first stuck on the backplane, and then a reflective film may be mounted on the backplane in accordance with the shape of the reflective film. As described above, since the bottom surface of the reflective film has an asymmetric pattern, it is possible to prevent the reflective film from being assembled with front and back surfaces reversed when the reflective film is mounted on the backplane, preventing fool-proofing.

The light guide plate may be mounted on the reflective film after the reflective film is mounted. As described above, since the bottom surface of the light guide plate is also an asymmetric pattern, it is possible to prevent the light guide plate from being assembled with front and back surfaces reversed, preventing fool-proofing. Since the light incoming surface of the light guide plate is not flat and the light incoming surface of the light guide plate can match with the surface of the backlight source facing the light guide plate, after the light guide plate is mounted, the backlight source may engage with the light guide plate accurately and fast due to the uneven surface of the backlight source and the uneven light incoming surface of the light guide plate, to complete the assembling of the light guide plate and the backlight source. In this case, the light outgoing surface of the first light emitting unit and the light outgoing surface of the second light emitting unit on the backlight source are both in contact with the light incoming surface of the light guide plate, and the light emerging from the light outgoing surface of the first light emitting unit and the light outgoing surface of the second light emitting unit can enter into the entire light incoming surface of the light guide plate, and can exit the light guide plate from the light outgoing surface of the light guide plate. It should be noted that when assembling the light guide plate and the backlight source, it is preferable that the sealant is provided on the periphery of the light guide plate and the backlight source.

Finally, a diffusion film, a lower prism film, an upper prism film, and a light-shielding film may be sequentially assembled on the light outgoing surface of the light guide plate. The upper prism film and the lower prism film may be collectively referred to as a prism film. As described above, since the bottom surfaces of the diffusion film and the prism film each have an asymmetric pattern, when assembling the diffusion film and the prism film, it is possible to prevent the diffusion film and the prism film from being assembled with front and back surfaces reversed, preventing fool-proofing.

After the assembling of the backlight module is completed, the light outgoing surface of the light guide plate is provided with a diffusion film and a prism film sequentially superimposed, and the back surface of the light guide plate is provided with a reflective film; a side of the prism film away from the light outgoing surface of the light guide plate is provided with a light-shielding film, a side of the reflective film away from the backlight surface of the light guide plate is provided with a backplane, and the rubber frame is disposed on the periphery of the light guide plate and the backlight source.

As described above, in the backlight module provided by the embodiment of the present disclosure, the light outgoing surface of the first light emitting unit and the light outgoing surface of the second light emitting unit form an angle of more than 180° and less than 270°, so that the light emitted from the first light emitting unit and the second light emitting unit can diffuse to an edge portion of the side face of the light guide plate, that is, the backlight source emits divergent light so that the light emerges relatively uniformly from the respective regions on the light outgoing surface of the light guide plate, thereby improving the uniformity of illuminance of the light outgoing surface of the light guide plate, and further improving the display effect of the display module.

As shown in FIG. 6, the embodiment of the present disclosure also provides a display module 1, which may include any of the backlight modules 0 described above. It may be understood that the display module may further include a display panel 10. A light guide plate and a light-shielding film may be provided on the backlight module, and the light-shielding film is provided on the side where the light outgoing surface of the light guide plate is located, and the display panel 10 is provided on the side of the light-shielding film away from the light outgoing surface of the light guide plate.

In the display module provided according to the embodiment of the present disclosure, the light outgoing surface of the first light emitting unit and the light outgoing surface of the second light emitting unit form an angle of more than 180° and less than 270°, so that the light emitted from the first light emitting unit and the second light emitting unit can diffuse to an edge portion of the side face of the light guide plate, and that the light may emerge relatively uniformly from the respective regions on the light outgoing surface of the light guide plate, thereby improving the uniformity of illuminance of the light outgoing surface of the light guide plate, and further improving the display effect of the display module.

The embodiment of the present disclosure also provides an electronic device which may include any of the display modules 1 described above. The electronic device may be an electronic wrist watch. Alternatively, the electronic device may be a liquid crystal panel, an electronic paper, a mobile phone, a tablet computer, a television, a display, a notebook computer, a digital photo frame, a navigator, and any product or component with a display function.

In the electronic device provided according to the embodiment of the present disclosure, the light outgoing surface of the first light emitting unit and the light outgoing surface of the second light emitting unit form an angle of more than 180° and less than 270°, so that the light emitted from the first light emitting unit and the second light emitting unit can diffuse to an edge portion of the side face of the light guide plate, and that the light may emerge relatively uniformly from the respective regions on the light outgoing surface of the light guide plate after being guided by the light guide plate, thereby improving the uniformity of illuminance of the light outgoing surface of the light guide plate, and further improving the display effect of the display module.

All of the above alternative technical solutions may employ any combination to form alternative embodiments of the present disclosure and will not be described in detail herein.

It should be noted that, in the drawings, the dimensions of the layers and regions may be exaggerated for clarity of illustration. In the embodiments of the present disclosure, the terms “first” and “second” are used for description purposes only and are not to be construed as indicating or implying relative importance.

The foregoing is merely for preferable embodiments of the present disclosure, and is not to be construed as limiting the present disclosure, and any modifications, equivalent substitutions, improvements, etc., which fall within the spirit and principles of the present disclosure, are intended to be embraced by the present disclosure.

1. A backlight module including a backlight source and a light guide plate, wherein the backlight source includes: a first light emitting unit, and a second light emitting unit positioned at least one end of the first light emitting unit,
the first light emitting unit and the second light emitting unit are disposed on the light incoming side of the light guide plate, and the light outgoing surface of the first light emitting unit and the light outgoing surface of the second light emitting unit form an angle of greater than 180° and less than 270°.

2. The backlight module according to claim 1, wherein the backlight module further includes a reflective film, a diffusion film, and a prism film, wherein the diffusion film and the prism film are sequentially superimposed on the light outgoing surface of the light guide plate, the reflective film is disposed on the back surface of the light guide plate;
the reflective film, the diffusion film, the prism film, and the light guide plate are each a cylinder, and the bottom surface of at least one cylinder of the reflective film, the diffusion film, the prism film, and the light guide plate has an asymmetrical shape.

3. The backlight module according to claim 1, wherein the backlight source further includes a base disposed on the light incoming side of the light guide plate, the first light emitting unit being disposed on a surface of the base close to the light guide plate,
a protrusion being formed on the surface of the base close to the light guide plate, wherein the protrusion is positioned at least one end of the first light emitting unit, a height of one end of the protrusion close to the first light emitting unit is larger than that of another end of the protrusion away from the first light emitting unit, and the second light emitting unit is disposed on a surface of the protrusion close to the light guide plate.

4. The backlight module according to claim 3, wherein the light incoming surface on the light incoming side of the light guide plate is provided as an uneven surface such that the shape of the light incoming surface of the light guide plate matches the shape of the surface of the backlight light source facing the light guide plate.

5. The backlight module according to claim 4, wherein the light outgoing surface of at least one of the first light emitting unit and the second light emitting unit is in contact with the light incoming surface of the light guide plate.

6. The backlight module according to claim 2, wherein the display regions of the reflective film, the diffusion film, the prism film, and the light guide plate are in a circular shape, and the bottom surfaces of the reflective film, the diffusion film, the prism film, and the light guide plate have the same shape and area, and are all in an asymmetrical shape.

7. The backlight module according to claim 1, wherein the backlight source includes one first light emitting unit and two second light emitting units, the two second light emitting units being disposed symmetrically at both ends of the first light emitting unit.

8. The backlight module according to claim 1, wherein the first light emitting unit and the second light emitting unit are light emitting diodes.

9. The backlight module according to claim 6, wherein the magnitude of the angle formed between the light outgoing surface of the first light emitting unit and the light outgoing surface of the second light emitting unit is proportional to the diameter of the circle.

10. The backlight module according to claim 1, wherein the light outgoing surface of the first light emitting unit and the light outgoing surface of the second light emitting unit form an angle of 183°.

11. The backlight module according to claim 6, wherein the diameter of the circle is 38.7 mm.

12. The backlight module according to claim 2, wherein the backlight module further includes a light-shielding film, a backplane, and a sealant,
wherein the light-shielding film is disposed on a side of the prism film away from the light outgoing surface of the light guide plate, the backplane is disposed on a side of the reflective film away from the back surface of the light guide plate, and the sealant is disposed on the periphery of the light guide plate and the backlight source.

13. A display module including a backlight module, the backlight module including a backlight source and a light guide plate, wherein the backlight source includes: a first light emitting unit, and a second light emitting unit positioned at least one end of the first light emitting unit,
the first light emitting unit and the second light emitting unit are disposed on the light incoming side of the light guide plate, and the light outgoing surface of the first light emitting unit and the light outgoing surface of the second light emitting unit form an angle of greater than 180° and less than 270°.

14. An electronic device including the display module according to claim 13.

15. The display module according to claim 13, wherein the backlight source further includes a base disposed on the light incoming side of the light guide plate, the first light emitting unit being disposed on a surface of the base close to the light guide plate,
a protrusion being formed on the surface of the base close to the light guide plate, wherein the protrusion is positioned at least one end of the first light emitting unit, a height of one end of the protrusion close to the first light emitting unit is larger than that of another end of the protrusion away from the first light emitting unit, and the second light emitting unit is disposed on a surface of the protrusion close to the light guide plate.

16. The display module according to claim 15, wherein the light incoming surface on the light incoming side of the light guide plate is provided as an uneven surface such that the shape of the light incoming surface of the light guide plate matches the shape of the surface of the backlight light source facing the light guide plate.

17. The display module according to claim 16, wherein the light outgoing surface of at least one of the first light emitting unit and the second light emitting unit is in contact with the light incoming surface of the light guide plate.

18. The display module according to claim 13, wherein the backlight module further includes a reflective film, a diffusion film, and a prism film, wherein the diffusion film and the prism film are sequentially superimposed on the light outgoing surface of the light guide plate, the reflective film is disposed on the back surface of the light guide plate;
the reflective film, the diffusion film, the prism film, and the light guide plate are each a cylinder, and the bottom surface of at least one cylinder of the reflective film, the diffusion film, the prism film, and the light guide plate has an asymmetrical shape,
wherein the display regions of the reflective film, the diffusion film, the prism film, and the light guide plate are in a circular shape, and the bottom surfaces of the reflective film, the diffusion film, the prism film, and the light guide plate have the same shape and area, and are all in an asymmetrical shape.

19. The display module according to claim 13, wherein the backlight source includes one first light emitting unit and two second light emitting units, the two second light emitting units being disposed symmetrically at both ends of the first light emitting unit.

20. The display module according to claim 18, wherein the magnitude of the angle formed between the light outgoing surface of the first light emitting unit and the light outgoing surface of the second light emitting unit is proportional to the diameter of the circle.
